(19) United States
(12) Patent Application Publication
(10) Pub. No.: US 2016/0197446 A1
(43) Pub. Date: Jul. 7, 2016

(54) CONNECTOR ASSEMBLY

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: JIE LI, Wuhan (CN); SHEN-FA TSAI, New Taipei (TW)

(21) Appl. No.: 14/611,958

(22) Filed: Feb. 2, 2015

(30) Foreign Application Priority Data
Jan. 5, 2015 (CN) 201510002419.5

(51) Int. Cl. H01R 27/02; H01R 9/18

(52) U.S. Cl. CPC H01R 27/02; H01R 9/18

(57) ABSTRACT

A connector assembly includes a mounting plate and a first connector. The first connector includes a first interface, a first connecting part, and a second connecting part. The second connecting part is substantially perpendicular to the first connecting part. The second connecting part is engaged with the mounting plate. The connector assembly further includes a second connector. The second connector is located between the first connecting part and the mounting plate. The second connector is engaged with the mounting plate. The second connector includes a second interface which has same plugging direction to the first interface.

### CROSS-REFERENCE TO RELATED APPLICATIONS

This application claims priority to Chinese Patent Application No. 201510002419.5 filed on Jan. 5, 2015, the contents of which are incorporated by reference herein.

### FIELD

The subject matter herein generally relates to a connector assembly.

### BACKGROUND

A connector assembly is used for transmitting data between two electronic devices. The electronic devices include different types of connectors to transmit data under different protocols.

### BRIEF DESCRIPTION OF THE DRAWINGS

Implementations of the present technology will now be described, by way of example only, with reference to the attached figures.

FIG. 1 is an exploded, isometric view of one embodiment of a connector assembly.

FIG. 2 is similar to FIG. 1, but viewed from another angle.

FIG. 3 is an assembled, isometric view of the connector assembly of FIG. 1.

FIG. 4 is similar to FIG. 3, but viewed from another angle.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a connector assembly.

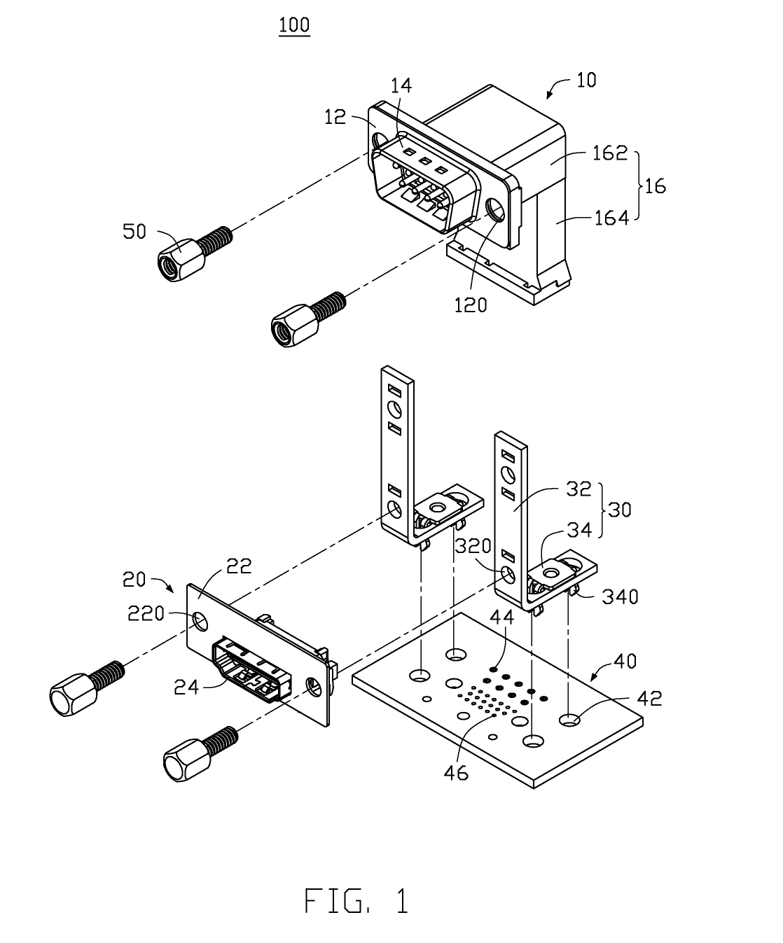

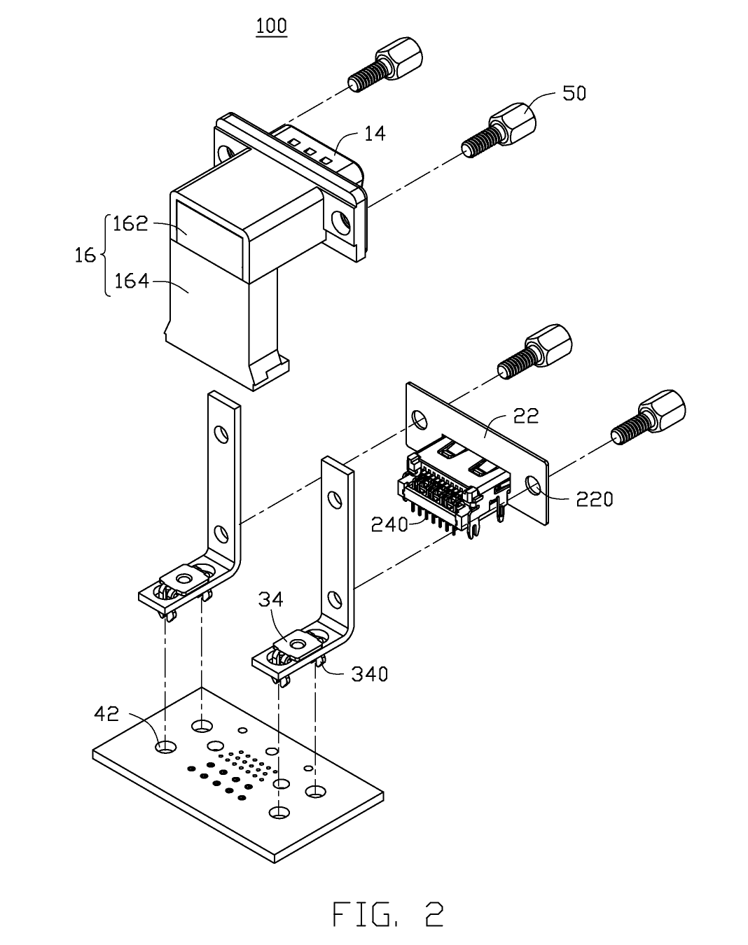

FIGS. 1 and 2 illustrate one embodiment of a connector assembly 100. The connector assembly 100 includes a first connector 10, a second connector 20, two fixing members 30, a mounting plate 40, and a plurality of screws 50. The first connector 10 and the second connector 20 work under different protocols. In at least one embodiment, the first connector 10 can be a video graphics adapter connector (D-SUB). The second connector 20 can be a high definition multimedia interface (HDMI) connector.

The first connector 10 includes a first plate 12, a first interface 14, and a connecting portion 16. The first interface 14 is engaged with the first plate 12. The first plate 12 defines two first holes 120. The two first holes 120 are located on the two sides of the first interface 14. The connecting portion 16 includes a first connecting portion 162 and a second connecting portion 164. The second connecting portion 164 extends from the first connecting portion 162 and is substantially perpendicular to the first connecting portion 162. The first connecting portion 162 is engaged with the first interface 14. The second connecting portion 164 can include a plurality of first pins. (not shown)

The second connector 20 includes a second plate 22 and a second interface 24. The second interface 24 is engaged with the second plate 22. The second plate 22 defines two second holes 220. The two second holes 220 are located on the two sides of the second interface 24. The second interface 24 includes a plurality of second pins 240.

Each of the two fixing members 30 includes a plate 32 and a fixing portion 34. The plate 32 defines a plurality of third holes 320. The fixing portion 34 includes a plurality of latching portions 340. In at least one embodiment, the plate 32 can be substantially L-shaped. The plurality of latching portions 340 is elastic. The mounting plate 40 defines a plurality of locking holes 42, a plurality of first fastening holes 44, and a plurality of second fastening holes 16. In at least one embodiment, the mounting plate 40 can be a base board or a motherboard of an electronic device.

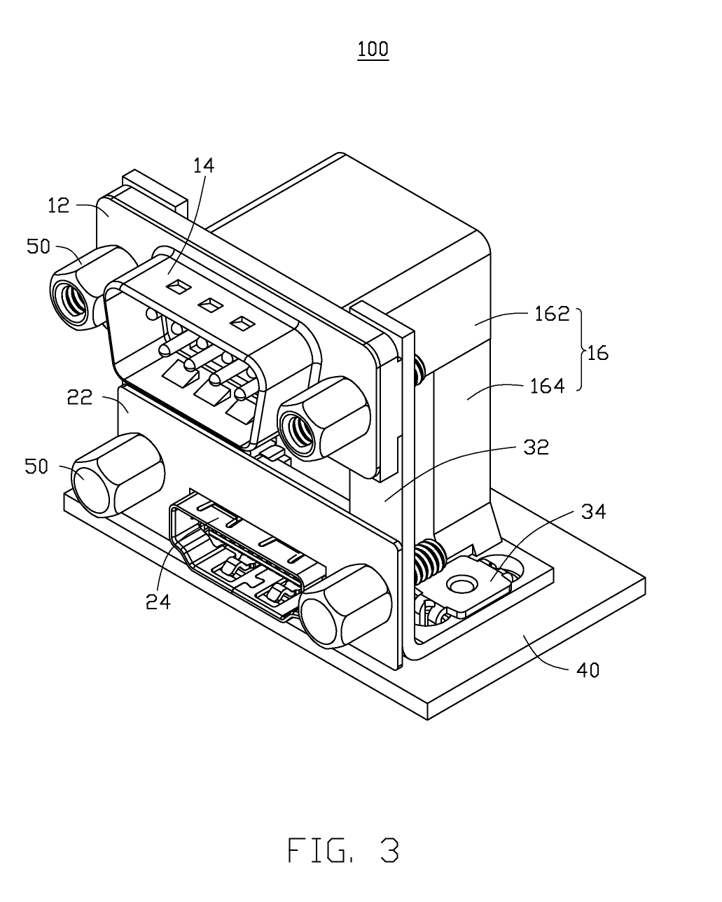

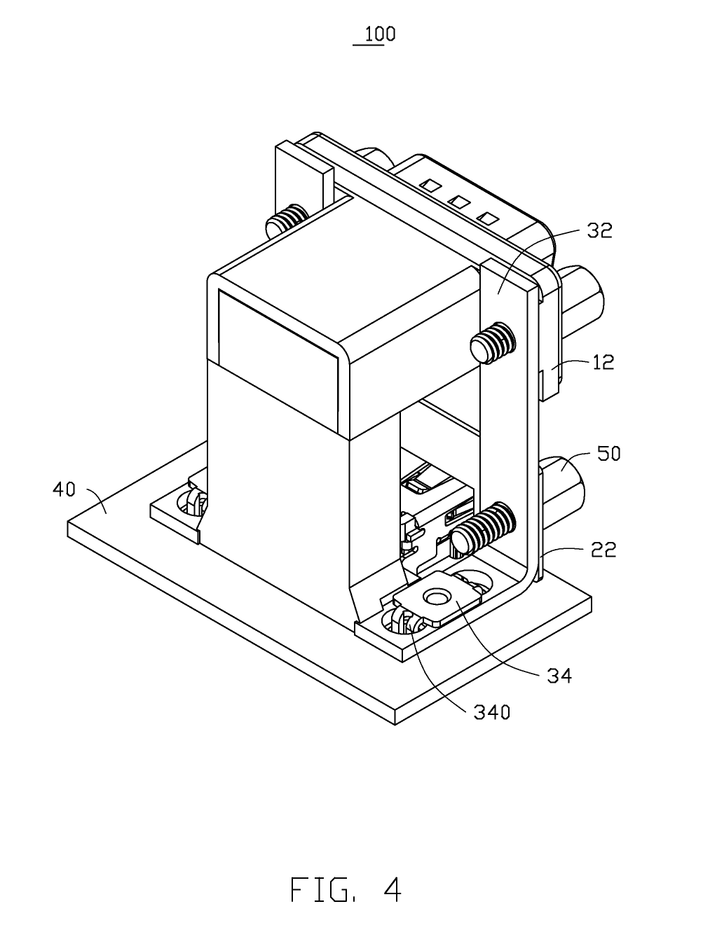

FIGS. 3 and 4 illustrate an assembled view of the connector assembly 100. Two of the plurality of screws 50 are engaged with the two first holes 120 and two of the plurality of third holes 320 (as shown in FIG. 1) fixing the first connector 10 together with one of the two fixing members 30. Two of the plurality of screws 50 are engaged with the two second holes 220 and two of the plurality of third holes 320 (as shown in FIG. 1) fixing the second connector 20 together with one of the two fixing members 30. The plurality of first pins (not shown in the figures) of the first connector 10 is engaged with the plurality of first fastening holes 44 (as shown in FIG. 1). The plurality of second pins 240 (as shown in FIG. 2) of the second connector 20 is engaged with the plurality of second fastening holes 46 (as shown in FIG. 1). The plurality of latching portions 340 is engaged with the plurality of third holes 320 and the plurality of locking holes 42 to fix the two fixing members 30 and the mounting plate 40 (as shown in FIG. 1). The first connector 10 and the second connector 20 are located on the one end of the plate 32. The mounting plate 40 is located on the other end of the plate 32. The second connector 20 is located between the first connecting portion 162 and the mounting plate 40. The second connector 20 is located on the one side of the second connecting portion 164. Two plugging directions of the first interface 14 and the second interface 24 are the same and are substantially parallel to the mounting plate 40.

The embodiments shown and described above are only examples. Many details are often found in the art such as the other features of a connector assembly. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A connector assembly comprising:
a mounting plate;
a first connector comprising a first interface, a first connecting part, and a second connecting part; and
a second connector comprising a second interface with same plugging direction to the first interface;
wherein the second connecting part is substantially perpendicular to the first connecting part, and is engaged with the mounting plate, the second connector is located between the first connecting part and the mounting plate.

2. The connector assembly of claim 1, wherein the first connector and the second connector work under different protocols.

3. The connector assembly of claim 2, wherein the first connector is a D-SUB connector.

4. The connector assembly of claim 2, wherein the second connector is a HDMI connector.

5. The connector assembly of claim 1, further comprising at least one fixing member and a screw, wherein the first connector comprises a first plate, the screw fixes the first plate to the fixing member.

6. The connector assembly of claim 5, wherein the second connector comprises a second plate, the screw fixes the second plate to the fixing member.

7. The connector assembly of claim 6, wherein the first plate and the second plate are substantially in a plane.

8. The connector assembly of claim 5, wherein mounting plate defines a plurality of locking holes, the at least one fixing member comprises a plate and a fixing portion, the plate defines a plurality of third holes, the fixing portion comprises a plurality of latching portions, the plurality of latching portions is engaged with the plurality of third holes and the plurality of locking holes to fix the at least one fixing member to the mounting plate.

9. The connector assembly of claim 8, wherein the plate is substantially L-shaped, the first connector and the second connector are located on the one end of the plate, the mounting plate is located on the other end of the plate.

10. The connector assembly of claim 1, wherein two plugging directions of the first interface and the second interface are substantially parallel to the mounting plate.

11. A connector assembly comprising:
a mounting plate;
a first connector comprising a first interface, a first connecting part, and a second connecting part; and
a second connector comprising a second interface;
wherein the second connecting part is engaged with the mounting plate, the second connector is located between the first connecting part and the mounting plate, two plugging directions of the first interface and the second interface are substantially parallel to the mounting plate.

12. The connector assembly of claim 11, wherein the first connector and the second connector work under different protocols.

13. The connector assembly of claim 12, wherein the first connector is a D-SUB connector.

14. The connector assembly of claim 12, wherein the second connector is a HDMI connector.

15. The connector assembly of claim 11, further comprising at least one fixing member and a screw, wherein the first connector comprises a first plate, the screw fixes the first plate to the fixing member.

16. The connector assembly of claim 15, wherein the second connector comprises a second plate, the screw fixes the second plate to the fixing member.

17. The connector assembly of claim 16, wherein the first plate and the second plate are substantially in a plane.

18. The connector assembly of claim 15, wherein mounting plate defines a plurality of locking holes, the at least one fixing member comprises a plate and a fixing portion, the plate defines a plurality of third holes, the fixing portion comprises a plurality of latching portions, the plurality of latching portions is engaged with the plurality of third holes and the plurality of locking holes to fix the at least one fixing member to the mounting plate.

19. The connector assembly of claim 18, wherein the plate is substantially L-shaped, the first connector and the second connector are located on the one end of the plate, the mounting plate is located on the other end of the plate.

20. A connector assembly comprising:
a mounting plate;
a first connector having a first connection interface, a first support portion coupled to the first connection interface and a second support portion coupled to the first support portion and mounted on the mounting plate; and
a second connector having a second connection interface, the second connector mounted to the mounting plate;
wherein, the first support portion of the first connector is substantially perpendicular to the second support portion of the first connector and the first connector is mounted on the mounting plate to position the first connection interface facing toward a first direction; and
wherein, the second connector is mounted to position the second connector between the first connector and the mounting plate with the second connection interface facing toward the first direction.
